(19) United States
(12) Patent Application Publication
(10) Pub. No.: US 2005/0226589 A1
(43) Pub. Date: Oct. 13, 2005

(54) Fiber-optic plug comprising crimped knobs

(76) Inventors: Johannes Hafner, Roth (DE); Ricarda Spitguer, Berg (DE)

Correspondence Address: HARRINGTON & SMITH, LLP, 4 RESEARCH DRIVE, SHELTON, CT, 06484-6212, US

(21) Appl. No.: 10/510,909

(22) PCT Filed: Apr. 9, 2003
(86) PCT No.: PCT/EP03/03688

§ 371 Date: May 9, 2005

(30) Foreign Application Priority Data
Apr. 10, 2002 (DE) 102157359

(51) Int. Cl. G02B 6/36

(52) U.S. Cl. 385/139; 385/86

(57) ABSTRACT

The invention relates to a fiber-optic plug/cable system that comprises a plug housing which is provided with one guide segment and one clamping element per fiber-optic cable for fastening the fiber-optic cable on the plug. Said clamping element has inner projections for anchoring it on the fiber-optic cable that are pressed into the cable sleeve by crimping. The fiber-optic cable has an outer sleeve, an inner sleeve and an optical fiber that is protected by a protective layer. The clamping element of the fiber-optic plug is provided on at least two opposite, axially extending sections of its inner wall with projections to be crimped with the inner (7) or outer (6) sleeve of the fiber-optic cable.

The present invention concerns a fiber-optic plug-cable arrangement according to the preamble of patent claim 1. Such an arrangement is known, for example, from DE 4,410,444.

Such fiber-optic plugs are needed to connect fiber-optic cables to devices in which light signals are converted, amplified, relayed, or processed. Fiber-optic plugs are needed in large number in systems that function with light signals, so a cost reduction in the production of such plugs has a great influence on the overall costs of such a system. Fiber-optic plugs may not take up too much space in order for it to be possible to arrange a large number of plugs on the smallest space. Furthermore, they must have a robust design for frequent plug insertion and tensile loads and they must guarantee high pull-out strengths. For the transmission of signals, it is important that the losses at the interface between cable end and device are kept as small as possible. It is important in this regard that the end face of the fiber-optic cable be flat and free of damage, such as scratches, cracks, etc. The plug-cable arrangement should be suitable for an automatic mounting as well as for a manual mounting. In addition, production can be speeded up and reduced in cost when it is possible to use injection molds from which the injection-molded part is removed rapidly and simply.

The present invention is based on the problem of improving a fiber-optic plug-cable arrangement of the kind described above in such a way that it can be manufactured more cost-effectively and more rapidly and that it is suitable for both automatic and manual mounting. This problem is solved in accordance with the claims.

Preferred embodiments of the present invention are claimed in the subclaims.

The fiber-optic plug-cable arrangement of the invention uses cables that have an outer and an inner sheathing. The outer sheathing is stripped at the cable end. Both sheathings are joined firmly to the plug by crimping. The projections that are pressed into the cable sheathing have a flat profile, by means of which, together with a slightly conical opening toward the cable end, it is possible to eject the plug from its injection mold by a simple translational motion of the press ram. Also contributing to this is the fact that a serrated profile is not present on the entire inner wall of the plug, but only on narrow axial segments, four of which, according to a preferred embodiment, are mutually arranged at an angular separation of 90°. Situated just above this serrated profile, viewed radially, specially shaped surfaces are found on the outer side of the plug for engaging the faces of a crimp tool and for making possible a precise crimping of the plug onto the end of the fiber-optic cable.

The invention will be discussed in greater detail below on the basis of the description of an embodiment example with reference to the drawing. Shown therein is the following:

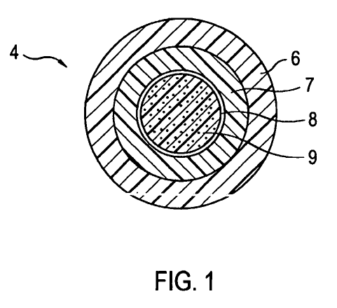

FIG. 1 the fiber-optic cable, in cross section, used for the arrangement of the invention;

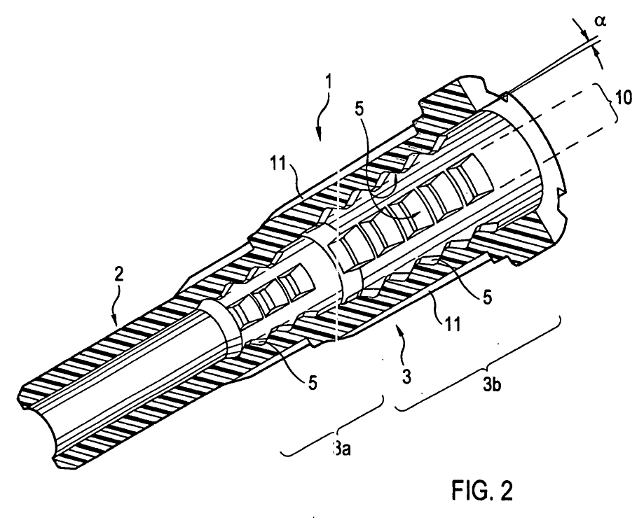

FIG. 2 a longitudinal cut-away view, in perspective, of the plug used for the arrangement of the invention;

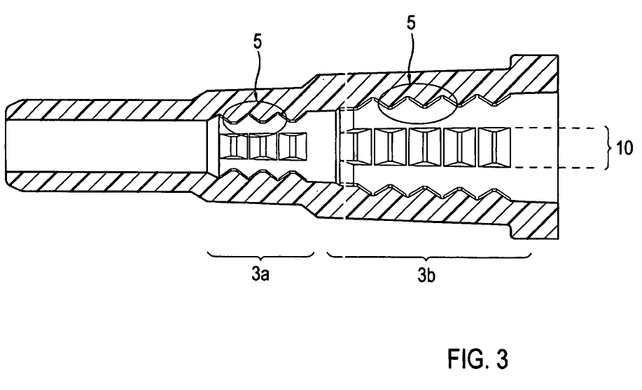

FIG. 3 the plug according to FIG. 2, in longitudinal section;

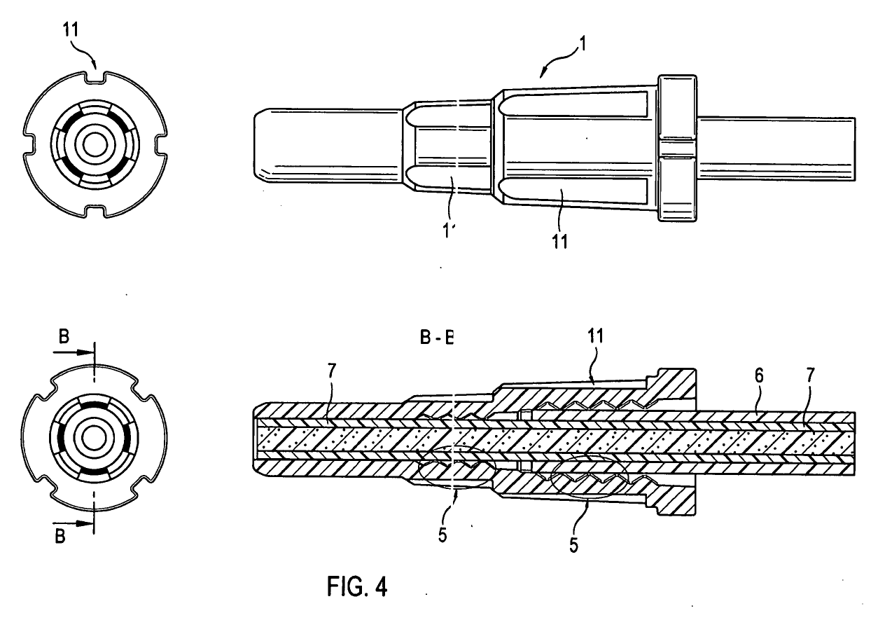

FIG. 4 the plug according to FIG. 2 with inserted and crimped fiber-optic cable; and

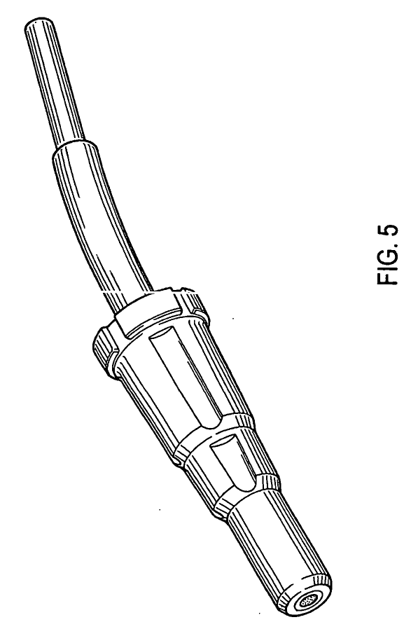

FIG. 5 a perspective view of the fiber-optic plug-cable arrangement of the invention.

FIG. 1 shows a cable 4 used for the fiber-optic plug-cable arrangement of the invention. From the outside to the inside, it consists of an outer sheathing 6 made of an appropriate PA plastic, which, as a rule, is colored for identification of the cable. This sheathing 6 surrounds an inner sheathing 7, which, in turn, rests on a polymer fiber 9, which is furnished with a protective coating 8. The fiber 9 involves a plastic fiber made of a polymer that is especially suitable for high data transmission rates for a transmission length of less than 100 m. The cable has an outer diameter of 2.3 mm with a core diameter of 980 μm.

FIG. 2 shows a longitudinal section through a perspective view of the plug used for the arrangement of the invention. The plug housing 1 has a plug segment 2 and a clamping segment 3 for attachment of the fiber-optic cable 4. The clamping segment 3, in turn, is divided into a plug-side region 3a with a reduced inner diameter and a cable-side segment 3b. The inner diameters of the segments 3a and 3b are chosen in such a way that a crimping of the plug in the plug segment 3a onto the inner cable sheathing 7 can occur and, in the cable-side clamping segment 3b, a crimping onto the outer sheathing 6 can take place. For this purpose, corresponding lengths of the outer sheathing 6 are stripped at the cable end of the fiber-optic cable, so that a length matching the fiber 9, surrounded by the inner sheathing 7, can be inserted into the clamping segment 3a and the clamping segment 3b is crimped onto the outer sheathing 6.

Placed in both clamping segments 3a, 3b are axially extending subregions 10 with projections on the inner wall of the plug housing. These are separated from one another in the radial direction by smooth wall regions, opposite which the projections 5 protrude inward. In the embodiment example shown here, four regions 10, mutually separated radially by 90°, are each arranged, with their projections 5, in the clamping segments 3a, 3b.

Surfaces 11 for introducing crimping tool faces are situated on the outer side of the tubular plug housing, precisely opposite the subregions 10 with the crimping profiles 5 on the inner side of the tubular plug housing.

The projections 5 have a smoothed serrated profile in the subregions 10, with at least the flanks of the projections 5 on the cable end side assuming an angle of less than 45° with respect to the longitudinal axis of the plug housing 1. The flanks on the face end side can, by contrast, be formed more steeply, even running perpendicular to the cable axis. At the same time, the entire clamping region has a slightly conically opening shape toward the cable side. The cone angle is approximately 2°. Together with the relatively flat serrated profiles of the projections 5 and together with the arrangement of the projections only in axial subregions of the inner wall of the plug housing 1, this makes possible the axial ejection of the plug from an injection mold, for which only a translational movement of an ejection ram is required. Thus, unlike the case for conventional serrations in the form of internal threads, it is not necessary to unscrew a mandrel out of the injection mold, this slowing down the production process and making the injection mold more expensive.

FIG. 3 shows the plug housing in cross section, clearly revealing the flat serrated profile in the regions 3a and 3b and their angular separation.

FIG. 4 shows a longitudinal view, partially cut away in the longitudinal direction and respectively in cross section, of the fiber-optic plug-cable arrangement of the invention. Evident in the upper left figure is the crimping region 11 on the outer side of the plug housing 1. The lower right section shows that the inner sheathing 7 and the end face of the fiber 9 terminate at a small distance from the plug-in end of the plug segment 2, so that the fiber is protected from scratches. It is further evident in FIG. 4 that the outer diameter of the plug housing is constructed in the region of the clamping segments 3a and 3b in such a way that, in both cases, the wall thickness is essentially identical, so that the deformation forces required for the crimping are also roughly identical.

FIG. 5 shows the fiber-optic plug-cable arrangement of the invention in a perspective view. The description of this embodiment example of the invention serves merely for illustration and is not to be understood as being limiting.

1. A fiber-optic cable arrangement with a plug housing, which, per fiber-optic cable, has a guide segment and a clamping segment for the attachment of the fiber-optic cable to the plug, wherein the clamping segment has projections on the inside for anchoring to the fiber-optic cable, which are pressed in the cable sheath by crimping,
characterized in that
the fiber-optic fiber cable has an outer sheathing, an inner sheathing, and a fiber-optic, protected by a protective layer, and
the claimping segment of the fiber-optic plug has projections on at least two axially extending subregions of its inner wall for crimping with the inner and outer sheathings of the fiber-optic cable.

2. The fiber-optic plug-cable arrangement according to claim 1, further characterized in that the clamping segment is divided into two regions:
a first region that lies toward the guide end and has an inner diameter adapted to the diameter of the inner cable sheathing and
a second region that lies on the cable side and has an inner diameter adapted to the diameter of the outer cable sheathing,
wherein the length of the stripped outer sheathing corresponds essentially to the small specified dimension of the length of the guide region plus that of the first clamping region.

3. The fiber-optic plug-cable arrangement according to claim 1, further characterized in that the axial regions, together with projections, form a regular or asymmetric serrated profile.

4. The fiber-optic plug-cable arrangement according to claim 1, further characterized in that the plug-in region has a cylindrical recess for the polymer fiber with protective layer, in which the fiber is held with little radial play and by means of which the face side of the fiber is somewhat retracted with respect to the head end of the plug housing.

5. The fiber-optic plug-cable arrangement according to claim 1, further characterized in that the clamping region expand conically toward the cable end in order to make possible a forced release from an injection mold.

6. The fiber-optic plug cable arrangement according to claim 5, further characterized in that the cone angle (a) is approximately 2°.

7. The fiber-optic plug-cable arrangement according to claim 5, further characterized in that at least the flanks of the serrated profile on the cable end side assume an angle of less than 45° with respect to the plug axis.

8. The fiber-optic plug-cable arrangement according to claim 1, further characterized in that four axially extending subregions with projections are mutually arranged at 90° angles, the width of each of the subregions in the circumferential direction being essentially identical to the width of the gaps in the circumferential direction between the subregions.
